(19) United States
(12) Patent Application Publication
(10) Pub. No.: US 2013/0326383 A1
(43) Pub. Date: Dec. 5, 2013

(54) VIBRATION DATA COLLECTION AND PROCESSING FOR A GAS TURBINE ENGINE

(71) Applicants: Roger Anthony Gatti, San Diego, CA (US); Warren James Wasson, Coronado, CA (US); Darin Asami Kapono Itamura, San Diego, CA (US); Laurent Tucker Hayward, Lasne (BE)

(72) Inventors: Roger Anthony Gatti, San Diego, CA (US); Warren James Wasson, Coronado, CA (US); Darin Asami Kapono Itamura, San Diego, CA (US); Laurent Tucker Hayward, Lasne (BE)

(21) Appl. No.: 13/488,226

(22) Filed: Jun. 4, 2012

(51) Int. Cl. G06F 3/048

(52) U.S. Cl. 715/771

(57) ABSTRACT

A method for collecting and processing vibration data from a turbine engine system is disclosed. The method comprises: receiving engine data from the turbine engine while in service, where the engine data include vibration data measured by one or more sensors disposed on the turbine engine. The method further comprises receiving user input through a user interface; processing the vibration data in response to the user input; and displaying the processed vibration data through the user interface, the processed data being displayed as a function of a time parameter.

### TECHNICAL FIELD

The present disclosure relates generally to a system and method for collecting and processing vibration data associated with a gas turbine engine.

### BACKGROUND

Vibration monitoring systems are used to protect turbine engines and associated equipment from damage due to excessive vibration levels. Such monitoring systems provide information that can be used to evaluate vibration problems and enable the users to trace the root cause before equipment availability is affected. Conventional vibration monitoring systems are not integrated with the turbine engine and thus require a standalone system or additional equipment to be connected to the engine when vibration monitoring is desired. Using a conventional vibration monitoring system, turbine engine operators often look to specialists and dedicated resources to collect the vibration data and perform the diagnostics.

U.S. Pat. No. 6,768,938 B2 to McBrien et al. describes a system and method for monitoring the vibration levels of gas turbine engines. The vibration monitoring system acquires vibration data from an engine and processes the data with advanced algorithms to determine engine component health, both in a diagnostic and prognostic fashion. The method includes the steps of measuring an operating parameter and a corresponding set of vibration amplitudes for a plurality of rotating components during a period of operation and normalizing the set of measured vibration amplitudes based on established amplitude limits.

### SUMMARY

A method and system for collecting and processing vibration data from a turbine engine are disclosed. According to one embodiment, the method comprises: receiving engine data from the turbine engine while in service, where the engine data include vibration data measured by one or more sensors disposed on the turbine engine. The method further comprises receiving user input through a user interface; processing the vibration data in response to the user input; and displaying the processed vibration data through the user interface, the processed data being displayed as a function of a time parameter.

According to another embodiment, the method comprises: receiving engine data from the plurality of turbine engines while in service, where the engine data include vibration data measured by a plurality of sensors disposed on the turbine engines. The method further includes receiving user input through a user interface; processing the vibration data in response to the user input; and displaying the processed vibration data through the user interface, the processed data being displayed as a function of a time parameter associated with at least one of the turbine engines.

According to still another embodiment, the system comprises a general data module configured to receive periodic data from a controller of a turbine engine, the periodic data representing operational states of the turbine engine; a vibration data module configured to receive vibration data from a measurement module associated with the turbine engine and generate a functional relationship between the vibration data and a time parameter according to user input, the vibration data including information about vibration of the turbine engine provided by a plurality of sensors associated with the turbine engine; a database configured to store the periodic data and the vibration data as historical data and provide the historical data in response to the user input; a historical data module configured to retrieve the periodic data and the vibration data from the database; and a display device configured to display the periodic data, the vibration data, and the historical data.

### BRIEF DESCRIPTION OF THE DRAWINGS

FIG. 1A is an illustration of an exemplary disclosed vibration data collection and processing system for a turbine engine;

FIGS. 1B and 1C illustrates exemplary configurations of sensors shown in FIG. 1A when placed on engine bearings;

FIG. 2 is an illustration of an exemplary disclosed multi-unit vibration data collection and processing system;

FIG. 3 is an illustration of another exemplary disclosed multi-unit vibration data collection and processing system;

FIG. 4 is an illustration of an exemplary user interface provided by the exemplary disclosed vibration data collection and processing system, showing a summary tab;

FIG. 5 is an illustration of another exemplary user interface provided by the exemplary disclosed vibration data collection and processing system, showing a break-down analysis;

FIG. 6 is an illustration of still another exemplary user interface provided by the exemplary disclosed vibration data collection and processing system, showing a spectrum tab;

FIG. 7 is an illustration of still another exemplary user interface provided by the exemplary disclosed vibration data collection and processing system, showing another spectrum tab;

FIG. 8 is an illustration of still another exemplary user interface provided by the exemplary disclosed vibration data collection and processing system, showing a waveform tab;

FIG. 9 is an illustration of still another exemplary user interface provided by the exemplary disclosed vibration data collection and processing system, showing an orbit tab;

FIG. 10 is an illustration of still another exemplary user interface provided by the exemplary disclosed vibration data collection and processing system, showing a module configuration tab;

FIG. 11 is an illustration of still another exemplary user interface provided by the exemplary disclosed vibration data collection and processing system, showing a bode tab;

FIG. 12 is an illustration of still another exemplary user interface provided by the exemplary disclosed vibration data collection and processing system, showing a polar tab;

FIG. 13 is an illustration of still another exemplary user interface provided by the exemplary disclosed vibration data collection and processing system, showing a centerline; and

FIG. 14 is an illustration of an exemplary disclosed process for collecting and processing vibration data.

### DETAILED DESCRIPTION

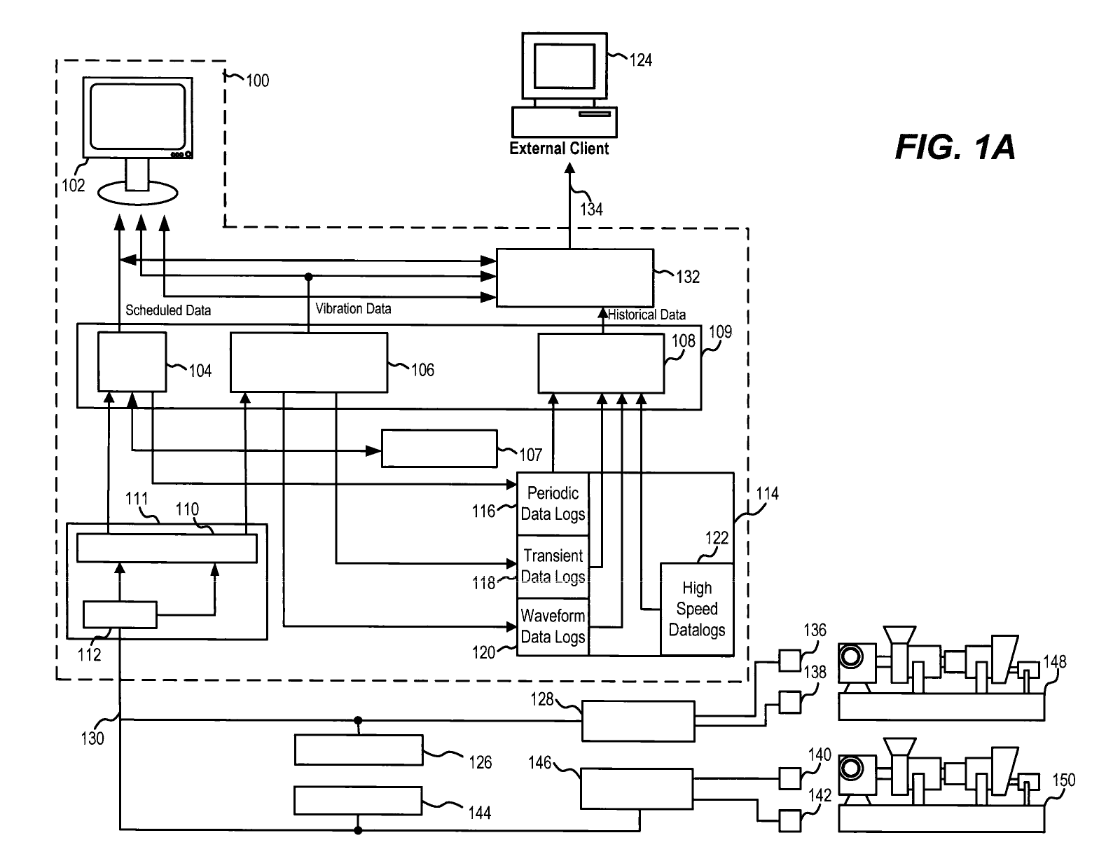

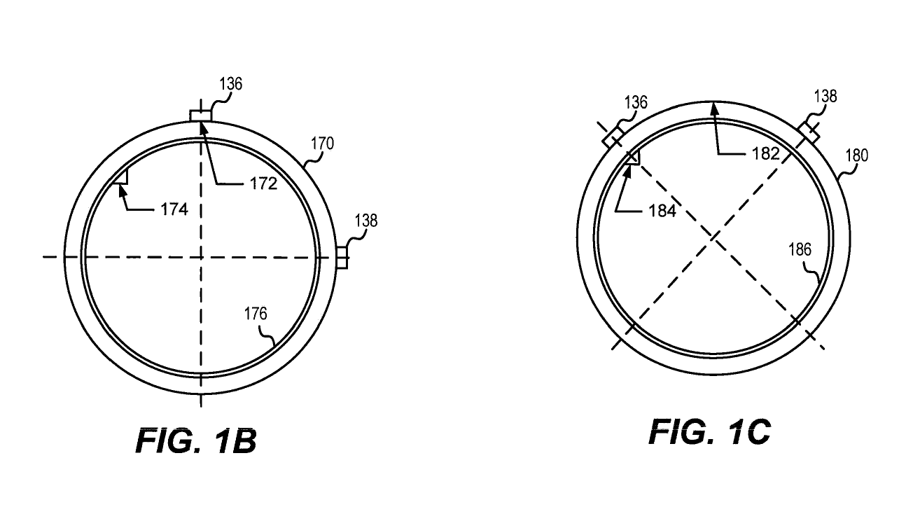

FIG. 1A illustrates an exemplary vibration data collection and processing system 100, according to one embodiment. In general, system 100 may be used to collect engine data, including operational data and vibration data, from a turbine engine system, such as turbine engine 148 or 150, process the engine data, and allow a user to access the engine data.

Specifically, system 100 may have, among other things, a display device 102, a general data module 104, a vibration data module 106, a historical data module 108, a communication interface 111, and a database 114. System 100 may be implemented on one or more computer systems including proper hardware and software components. For example, general data module 104, vibration data module 106, and historical data module 108 may include computer executable instructions stored on a computer readable medium 109, such as a RAM, a ROM, a CD-ROM, a flash drive, a hard drive, a solid state drive, etc. The instructions associated with general data module 104, vibration data module 106, and historical data module 108 may be executed by a processor within system 100 to carry out the methods and processes described herein. The instructions associated with general data module 104, vibration data module 106, and historical data module 108 may be written with a programming language, such as C, C++, BASIC, FORTRAN, etc. In addition, general data module 104, vibration data module 106, and historical data module 108 may be software components running on an existing turbine engine control system. Alternatively, general module 104, vibration data module 106, and historical data module 108 may be implemented on dedicated hardware systems such as programmable logic devices and coupled to existing control system of a turbine engine.

Communication interface 111 may communicate with external components or systems such as a turbine engine controller 126 or a vibration measurement module 128. Communication interface 111 may receive engine data from the external components or systems and provide the engine data to the general data module 104 and the vibration data module 106. Further, communication interface 111 may further include one or more communication cards 112 and associated communication programs 110. For example, communication card 112 may take the form of a ControlNet PCI Communication Interface Card manufactured by Rockwell International Corp and communication programs 110 may include an RSLinx program provided by Rockwell Automation, Inc.

Communication cards 112 operate in conjunction with communication programs 110 to receive the data from the external components or systems, process the data, and provide the data to the modules for further processing. Communication cards 112 may be coupled to turbine engine controller 126 and vibration measurement module 128 through a computer network 130, such as an Internet, Ethernet, WAN, LAN, Wi-Fi, ControlNet, or other general or proprietary network structures known in the art.

Database 114 may be a known database type, such as a relational database, an operational database, a hierarchical database, or other proprietary database types. Database 114 may include a plurality of data logs such as periodic data logs 116, transient data logs 118, waveform data logs 120, and high speed data logs 122 for storing corresponding data received from turbine engine controller 126 and measurement module 128. Database 114 may be implemented on a computer readable medium as described above and accessed by other system components, such as general data module 104, vibration data module 106, and historical data module 108. As such, database 114 and the data logs therein may provide necessary data to the modules according to the methods described herein and receive data from the system components to update the data stored therein.

Further system 100 may be coupled to an external client 124 to allow a user to access system 100 remotely. For example, system 100 may include a network card 132, which communicates with external client 124 through a computer network 134. As such, the user may log into system 100 through external client 124 and access the data and function therethrough.

Engine controller 126 may be a turbine engine controller known in the art and integrated within a turbine engine. Engine controller 126 may monitor and control the operation of the turbine engine and transmit data to system 100 reflecting the operational states of the turbine engine, such as speed, air temperature, system time, etc. For a two-stage turbine engine, which includes a gas producer and a power turbine, engine controller 126 may monitor and control the combustor, the gas producer, which is the driving equipment, and the power turbine, which is the driven equipment. For example, controller 126 may monitor the rotational speeds of the shafts in both the gas producer and the power turbine. Controller 126 may further monitor operation of any driven equipment, such as a power generator, coupled to the turbine engine. Controller 126 may transmit the data to system 100 at regular time intervals, such as one transmission per second. This data transmitted is referred to as scheduled data. Controller 126 may transmit the scheduled data at shorter or longer time intervals or irregular time intervals.

Vibration measurement module 128 may be a multi-channel general purpose vibration monitor that supports measurements of dynamic inputs such as vibration, pressure, and strain on various engine components, such as the compressor, the combustor, the gas generator, the power turbine, the pump, the driven equipment etc. Measurement module 128 may be coupled with controllers 126 through appropriate adapters or interfaces and may be directly coupled with system 100 through network 130. Alternatively, measurement module 128 may be integrated with controller 126 in a single unit. Measurement module 128 may poll or request data reflecting measurements of vibration or pressure from a plurality of sensors (136, 138). This data may include waveform data recording the magnitude and phase of the vibration and pressure measured at various parts of the turbine engine system. Measurement module 128 may then transmit the waveform data to system 100 upon request by system 100. The waveform data so transmitted by measurement module 128 may be referred to as unscheduled data. Alternatively, measurement module 128 may transmit the waveform data to system 100 periodically as scheduled data without the request from system 100.

Sensors 136 and 138 may be vibration, motion, or pressure sensors known in the art. The vibration and motion sensors may be placed on engine components, such as bearings or shaft housings, associated with the compressor, the combustor, the gas generator, the power turbine, the pump, etc. In addition, sensors 136 and 138 may also be placed on any driven equipment of the turbine engine, such as a power generator, where vibration parameters need to be monitored. The pressure sensors may be disposed within the combustor or turbine inlet where gas pressure needs to be monitored. Each of sensors 136 and 138 may be referred to as a channel. In other embodiments, more than two sensors may be used for each turbine engine.

Sensors 136 and 138 may further be grouped in pairs as shown in FIGS. 1B and 1C, where each pair measures the vibrations along two respective orthogonal directions on an engine component. In one embodiment, as shown in FIG. 1B, sensors 136 and 138 can be grouped as a pair and may be placed on a shaft bearing 170 along the 0° (vertical) and 90° (horizontal) directions, respectively, with respect to the engine top dead center 172 and looking from the engine exhaust towards the engine inlet. Sensors 136 and 138 are stationary with respect to the shaft housing that supports bearing 170. As such, the location of sensor 136 may be referred to as 0°, while the location of sensor 138 may be referred to as 90° R, indicating its location at 90° on the right side of the engine top dead center.

In another embodiment, as shown in FIG. 1C, sensors 136 and 138 can be grouped as a pair and be placed on a shaft bearing 180 in the −45° and +45° directions, respectively, again with respect to the engine top dead center 182 and looking from the engine exhaust towards the engine inlet. As such, the location of sensor 136 may be referred to as 45° L., indicating its location at 45° on the left side of the engine top dead center, while the location of sensor 138 may be referred to as 45° R., indicating its location at 45° on the right side of the engine top dead center. Further, the sensors pairs may be oriented in different directions on different components. In general, a total of 5-6 pairs of sensors are used on various parts of the gas producer and the power turbine to monitor the vibration of the rotational components therein.

In further embodiments, as shown in FIGS. 1B and 1C, the phase information of the vibration data detected by sensor pair 136 and 138 may be determined with reference to respective trigger points 174 and 184 disposed on shafts 176 and 186. For example, when trigger point 174 in FIG. 1B passes sensor 136, sensor 136 is triggered and transmits a trigger signal to measurement module 128. The trigger signal is then used as a reference to determine the time delay of a peak value of the vibration data. This time delay, converted to an angular measurement in degrees, is referred to as the phase lag of the vibration data. The phase lag indicates the degrees the shaft rotates after the trigger signal, until the peak value of vibration data is detected. In addition, sensors 136 and 138 may be triggered when shafts 176 and 186 rotates either clockwise or counterclockwise.

According to still another exemplary disclosed embodiment, system 100 may further includes a configuration file module 107, which stores basic configuration data in connection with the turbine engine being monitored and the user information associated with the turbine engine. For example, configuration file module 107 may include a memory for storing one or more data files created by a user or a turbine manufacturer on a per project basis. Configuration file module 107 contains information such as customer name, engine type, logging information, sensor orientation, etc. The data files stored in the configuration file module 107 may be created in the Extensible Markup Language (XML) format. During operation of system 100, vibration data module 106 may read the configuration data from module 107 and display the configuration data along with the engine data on display device 102. In addition, system 100 may allow a user to modify or delete configuration data in module 107 through user input devices such as a mouse or a keyboard.

According to another exemplary disclosed embodiment, system 100 may be integrated with an existing control system of a turbine engine system, such as turbine engine 148. For example, general data module 104, vibration data module 106, historical data module 108, communication program 110, and database 114 may be installed to the existing control system as program components during a system upgrade or maintenance. Communication card 112 may be inserted into the main board of the control system in the same upgrade procedure. Additionally, measurement module 128 and associated sensors 136 and 138 may be coupled to turbine engine system 148 with limited modifications. As such, system 100 and the associated functions may be provided to the user through the existing control system without major structural or operational changes to turbine engine 148.

According to a further embodiment, system 100 provides data collection and processing while the turbine engine is in service. As used herein, the phrase “in service” corresponds to operation of the turbine engine to produce desired power, and does not correspond to bench testing the engine or any maintenance-based operation of the engine. Unlike conventional systems, in which the turbine engine must operate in a testing mode or in a laboratory environment, system 100 allows an engine operator to monitor the vibration of the turbine engine and diagnose any abnormal vibrations or pressures without interrupting the operation of the engine to provide desired power. Thus, system 100 may collect and process the vibration data without affecting the power productivity of the turbine engine.

According to a still further embodiment, system 100 may collect and process vibration data from a fleet of turbine engine systems, such as turbine engines 148 and 150. Specifically, turbine engines 148 and 150 may each include a respective engine controller (126, 144), a respective vibration measurement module (128, 146), and a respective set of sensors (136, 138 and 140, 142). Engine controllers 126 and 144 and measurement modules 128 and 146 transmit engine data including operational data and vibration data to system 100 through network 130. System 100 may then process the engine data from the individual turbine engine as described herein. In addition, system 100 may compare the engine data collected from the fleet of turbine engines and allow a user to access the comparison results through display device 102. As described above, system 100 may collect and process the engine data while the fleet of turbine engines 148 and 150 are in service. System 100 does not require turbine engines 148 and 150 to be taken out of service in order to perform the data collection and processing described herein. Turbine engines 148 and 150 do not need to operate in a testing mode or in a laboratory environment for system 100 to collect and process the engine data.

According to a still further embodiment, turbine engines 148 and 150 may be located in different geographical locations, while system 100 may be coupled to engine controllers 126 and 144 and measurement modules 128 and 146 from a remote location different from those of turbine engines 148 and 150. As such, system 100 allows a user to remotely access and process the engine data collected from a fleet of turbine engines that are themselves distributed at different locations.

According to a still further embodiment, system 100 may be co-located with one of turbine engines 148 and 150, while providing engine data collected from the turbine engines to a user through external client 124. As such, the user may interact with system 100 through external client 124 and perform data collection and processing therefrom.

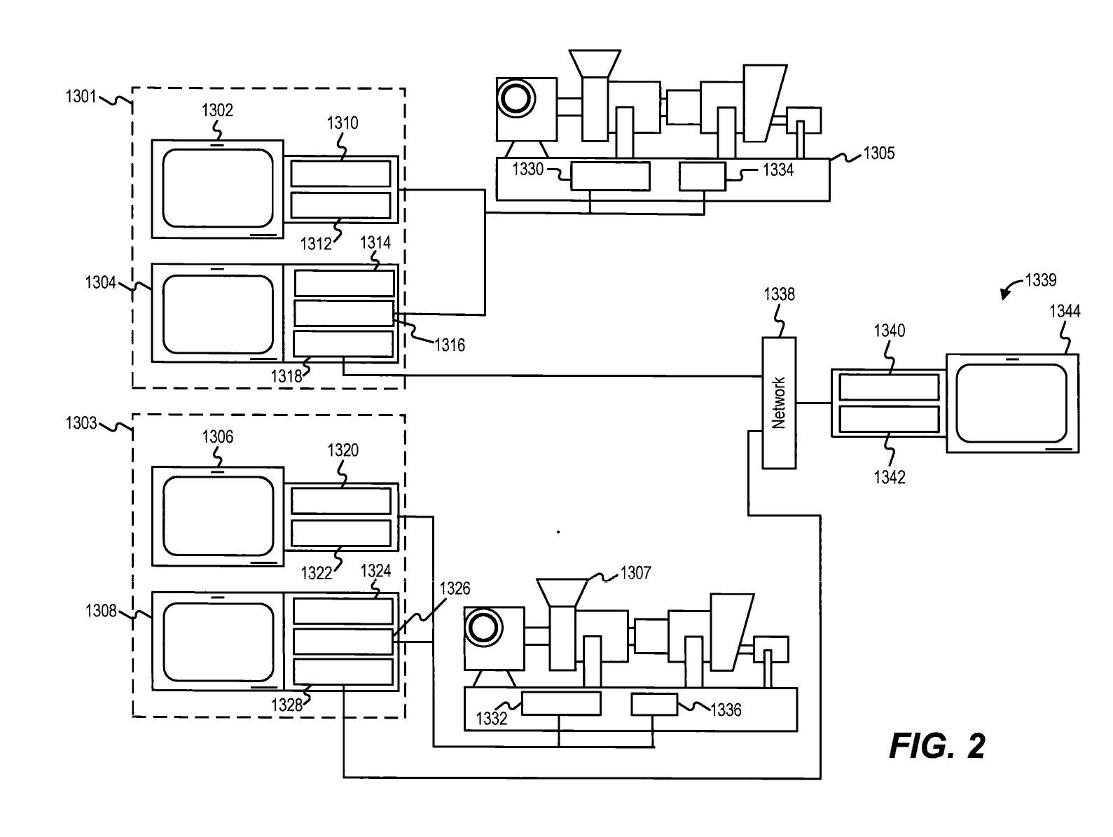

System 100 also allows easy integration with other similar systems, thereby facilitating distribution and integration of vibration data collected from a fleet of turbine engines. In particular, a plurality of vibration data collection systems, similar to system 100, may be integrated to facilitate collecting and processing of vibration data from multiple turbine systems. FIG. 2 illustrates an exemplary embodiment of a multi-unit vibration data collection system 1300.

System 1300 includes a plurality of single unit data collection systems 1301 and 1303 integrated with respective turbine systems 1305 and 1307. Systems 1301 and 1303 generally correspond to system 100. Specifically, system 1301 includes a plurality of display devices 1302 and 1304, which may be located at different geographical locations. System 1301 further includes a plurality of general data modules 1310 and 1314 and a plurality of historical data modules 1312 and 1316, which interact with the users through respective display devices 1302 and 1304 and the respective input devices, such as a mouse or a keyboard. The general data modules 1310 and 1314 may be substantially similar to general data module 104. Similarly, historical data modules 1312 and 1316 may also be substantially similar to historical module 108. In addition, system 1301 further includes a vibration data module 1318, which may be substantially similar to vibration data module 106. System 1301 receives vibration-related data from a measurement module 1330 and an engine controller 1334 associated with turbine system 1305. As such, system 1301 allows users to access and process the vibration data of turbine system 1305 through display devices 1302 and 1304, respectively.

System 1303 includes similar elements and structures as those of system 1301 and thus allows the users to access and process the vibration data of turbine system 1307 through display devices included therein.

In addition, multi-unit system 1300 may further include an external terminal 1339 for a user to access and process the vibration data collected from both turbine systems 1305 and 1307. In particular, external terminal 1339 may include a general data module 1340 and a historical data module 1342, and a display device 1344, similar to those depicted in FIG. 1A. External terminal 1339 may communicate with systems 1301 and 1303 through a network 1338 based on known communication protocols. Network 1338 may be a computer network or control network known in the art. External terminal 1339 may receive vibration data from system 1301 and 1303 and provide user with access to the vibration-related data collected from turbine system 1305 or 1307.

According to a further embodiment, systems 1301 and 1303 may be co-located with respective turbine engines 1305 and 1307, while system 1339 may be coupled to systems 1301 and 1303 from a remote location. As such, systems 1301 and 1303 may allow a local user to access and process the engine data collected from respective turbine engines 1305 and 1307, and system 1339 may allow a user to remotely access and process the engine data.

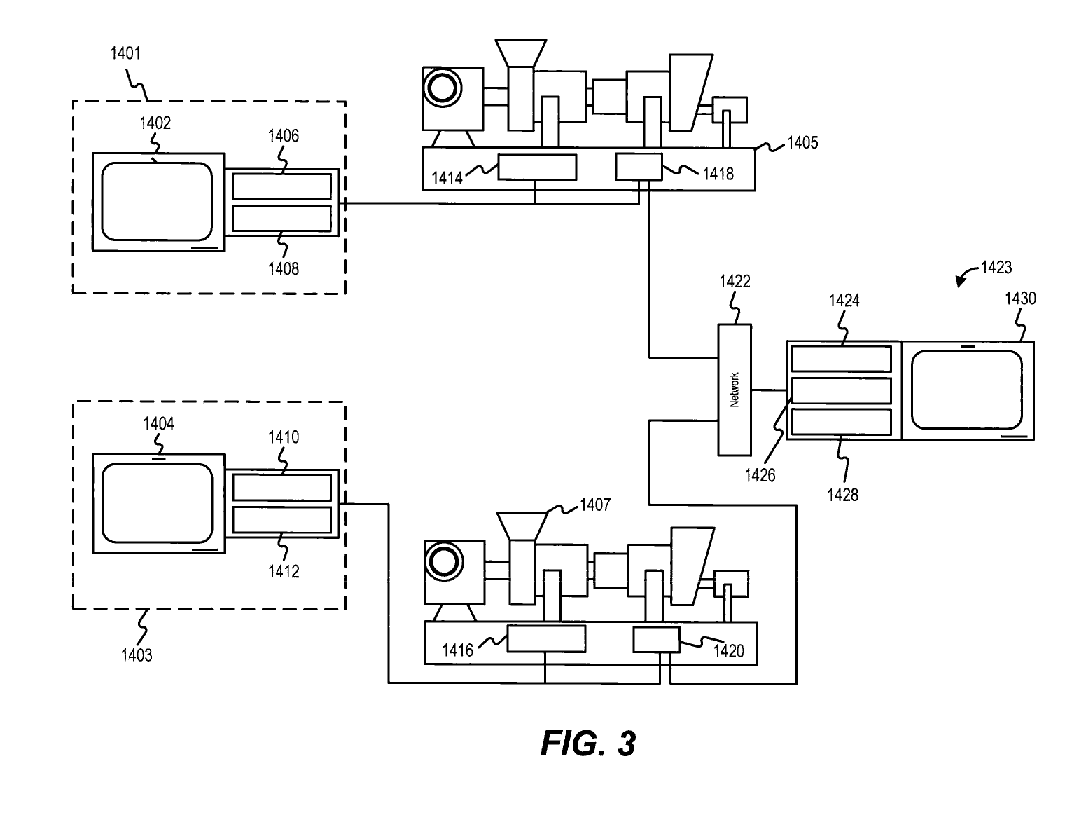

FIG. 3 illustrates another multi-unit vibration data collection system 1400, according to another exemplary disclosed embodiment. System 1400 includes a plurality of data collection systems 1401 and 1403, similar to system 100 depicted in FIG. 1A. Systems 1401 and 1403 are coupled to turbine systems 1405 and 1407 and receive engine data from respective measurement modules 1414 and 1416 and engine controllers 1418 and 1420. System 1401 includes a general data module 1406, a historical data module 1408, and a display device 1402 for a user to access the data collected from turbine system 1405. Similarly, system 1403 includes a general data module 1410, a historical data module 1412, and a display device 1404 for a user to access the data collected from turbine system 1407. Further, systems 1401 and 1403 may not include any vibration data modules. As a result, systems 1401 and 1403 may not provide the user with the ability to access and process unscheduled vibration data provided by measurement modules 1414 and 1416. Nevertheless, systems 1401 and 1403 can still provide access to scheduled vibration data. According to a further embodiment, the scheduled vibration data are listed and displayed in text form to the user through display devices 1402 and 1404. As such, systems 1401 and 1403 may be similar to conventional turbine control systems.

System 1400 further includes an external terminal 1423 coupled to controllers 1418 and 1420 of turbine systems 1405 and 1407 and receives vibration-related data of respective turbine systems. External terminal 1423 includes a general data module 1424, a historical data module 1426, a vibration data module 1428, and a display device 1430, similar to those depicted in FIG. 1. External terminal 1423 may receive the vibration-related data, including those data provided by measurement modules 1414 and 1416, through respective engine controllers 1418 and 1420, and process the engine data. External terminal 1423 may then allow the user to access and process the vibration data as described herein.

Further, systems 1401 and 1403 may be co-located with respective turbine engines 1405 and 1407, while system 1423 may be coupled from a remote location to measurement devices 1418 and 1420 associated with respective turbine engines 1405 and 1407. As such, systems 1401 and 1403 may allow a local user to access and process the engine data collected from respective turbine engines 1405 and 1407, and system 1423 may allow a user to remotely access and process the engine data.

### INDUSTRIAL APPLICABILITY

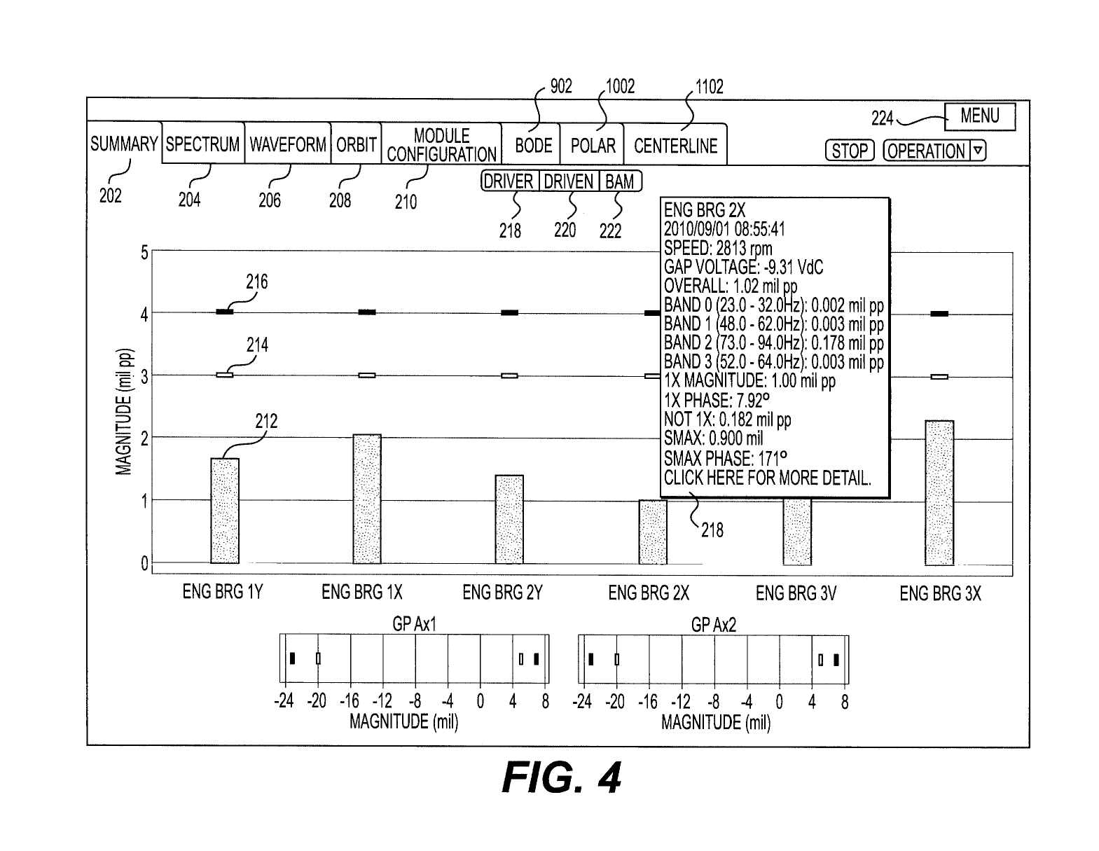

Operation of the systems shown in FIGS. 1A-3 is further described hereinafter with references to FIGS. 4-14. In particular, system 100 may be implemented in any turbine engine system that includes suitable turbine engine controller 126 and vibration measurement module 128, as described above. System 100 receives or requests engine data from controller 126 and measurement module 128 through communication interface 111. The engine data so collected by system 100 may include operational data provided by controller 126, indicating the operational conditions or states of the turbine system, such as the rotational speeds of various shafts, the temperatures at various locations, etc. The engine data may further include vibration data provided by measurement module 128, comprising waveform data that reflects the characteristics of the vibration and pressure of various engine components, such as the main shaft, bearings, or combustor. The waveform data may comprise information on the magnitudes and phases of the vibrations.

The waveform data is provided by measurement module 128 based on measurements collected from sensors 136-142, as described above. The waveform data from measurement module 128 may further be passed to controller 126 for monitoring, alarm, and shutdown purposes. This data may be part of scheduled traffic supported by control network 130. The measurement module also provides additional data that may not be required for machinery protection, but is beneficial for diagnostic uses. These additional data may be part of unscheduled traffic on control network 130.

General data module 104 receives turbine operational data from the engine controller and provides the operational data to display device 102 for viewing. This data may be updated periodically (e.g., once per second) and includes all analog, discrete, alarm, shutdown, and status tags available from controller 126. These data including, for example, rotational speed, engine temperature, etc., may be referred to as “one second data.” General data module 104 also records historical data in periodic intervals of 10 seconds, 1 minute, 1 hour and daily, and produces periodic data logs 116 in database 108 including these data for later access and processing.

Vibration data module 106 polls the unscheduled data from measurement module 128 and provides them to display device 102 for display and to database 108 for storage in transient data logs 118. Further, vibration data module 106 provides data analysis on the vibration data collected from measurement module 128. According to one embodiment, vibration data module 106 generates functional relationships between the vibration data and other data or parameters. For example, vibration data module 106 may determine a functional relationship between the vibration data and a time parameter, such as time, rotational speed, frequency, etc. Specifically, the functional relationship may include waveform data representing the magnitude of the vibration as a function of time. The functional relationship may include spectrum data representing the vibration data in a frequency range. The functional relationship may further represent a magnitude or a phase of the vibration as a function of engine speed. The functional relationship may further represent a variation of a combination of the magnitude and phase of the vibration within a time period. Still further, the functional relationship may represent a variation of a shaft center within a time period based on the vibration data provided by the sensors.

Additionally, vibration data module 106 may include a Burner Acoustic Monitoring (BAM) function that processes data from pressure transducers monitored by measurement module 128 and facilitates the monitoring of combustor oscillations within certain frequency ranges. Accordingly, vibration data module 106 may receive or obtain data from the pressure/acoustic sensor placed in or close to the combustor, process the data, and present the data to the user through display device 102.

Historical data module 108 accesses historical data recorded and processed by general data module 104 and vibration data module 106 for use by any client (e.g., a local client or a remote client 124) that requests them.

General data module 104, vibration data module 106, and historical data module 108 operate in conjunction to provide one or more graphical user interfaces (GUIs) through display device 102 or external client 124 for a user to access, view, and process the data collected from controller 126 and module 128. In addition, general data module 104 and vibration data module 106 may receive user input or commands through other user interfaces, such as mouse or keyboard, and process the data in accordance with user input. FIG. 4 illustrates an exemplary disclosed user interface 200 generated by system 100. User interface 200 includes a plurality of tabs for the user to access, view, and process the data according to the embodiments disclosed herein. For example, the tabs include a summary tab 202, a spectrum tab 204, a waveform tab 206, an orbit tab 208, and a module configurations tab 210.

According to one embodiment, summary tab 202 is an initial screen that system 100 displays to the user upon logging in. This tab presents the peak-to-peak vibration magnitude (mil pp) detected by individual vibration sensors 136-142. The vibration magnitudes are mapped to respective bar elements 212. Each bar element is associated with a sensor identifier, which indicates the location of the associated sensor. For example, “Eng Brg 1Y” may identify sensor 136 located at 0°, as shown in FIG. 1B, on an engine bearing 1, while “Eng Brg 1X” may identify sensor 138 located at 90° R, as shown in FIG. 1B, on same engine bearing 1. Similarly, “Eng Brg 2Y” may identify sensor 142 located at 45° R, as shown in FIG. 1C, on an engine bearing 2, while “Eng Brg 2X” may identify sensor 140 located at 45° L, as shown in FIG. 1C, on same engine bearing 2. Similar definitions may apply to additional sensors Eng Brg 3Y and Eng Brg 3X, which are placed on an engine bearing 3. As such, Eng Brg 1Y and Eng Brg 1X identify the sensor pair that measure vibrations of engine bearing 1 in two orthogonal directions (Y and X directions). Similarly, sensors Eng Brg 2Y and Eng Brg 2X identify the sensor pair that measures vibrations of engine bearing 2, while sensors Eng Brg 3Y and Eng Brg 3X identify the sensor pair that measures vibrations of engine bearing 3.

As described above, the height of each bar element 212 indicates the overall magnitude of the vibration detected by the associated sensor. According to another embodiment, the height of individual bar element 212 changes periodically in response to the vibration data received from module 128. For example, system 100 may update the heights of bar elements 212 each second, when new vibration data are received from module 128. As a result, summary tab 202 provides continuous visualization and monitoring of the engine vibrations.

According to a still further embodiment, summary tab 202 may further indicate threshold values 214 and 216 corresponding to magnitude limits that would trigger system alarm and system shutdown, respectively. The alarm and shutdown limits are graphically depicted for each sensor in summary tab 202 to provide an instant and continuous visual comparison between the threshold values 214 and 216 and the vibration magnitude detected by each sensor. Further, when alarm limits 214 is reached at a sensor, the graph shown in FIG. 4 turns, for example, yellow, and when shutdown limits 216 is reached, the graph turns, for example, red.

According to a still further embodiment, system 100 allows a user to view detailed information provided by each sensor by selecting one of bar elements 212 shown in FIG. 4. For example, the user may use a user input device, such as a mouse or keyboard, to select a bar element 212 in summary tab 202. In response, system 100 generates a popup window 218 showing a list of data received from controller 126 and module 128 and associated with the selected bar element. The list of data may include, for example, an identification of the selected sensor (e.g., “Eng Brg 2X”), a system data and time, a current speed of the component associated with the sensor, and a detailed vibration analysis, such as vibration magnitudes within individual frequency bands (e.g., “Band 0,” “Band 1,” “Band 2,” and “Band 3”) and magnitude and phase information at the synchronous frequency (“1X”). The break-down analysis will be further described hereinafter.

According to a still further embodiment, summary tab 202 may include button elements 218-222 for the user to select a preset group of sensors. For example, when “Driver” button 218 is selected, summary tab 202 shows the vibration data provided by sensors placed on a gas producer, which drives a power turbine. When “Driven” button 220 is selected, summary tab 202 shows the vibration data provided by sensors placed on the power turbine, which is driven by the gas producer. When “BAM” button 222 is selected, summary tab 202 shows the vibration data provided by the pressure sensor disposed within or close to a combustor of the turbine engine system.

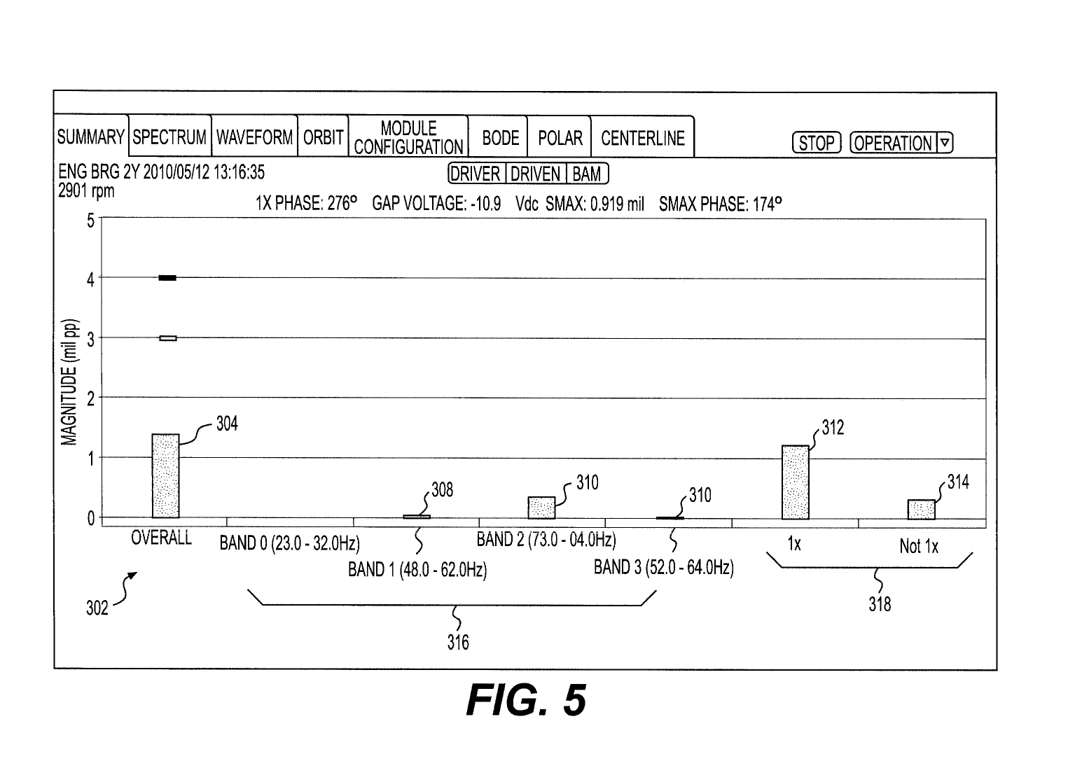

According to a still further embodiment, as shown in FIG. 5, summary tab 202 may provide a break-down analysis of the vibration data received from module 128. For example, the user may activate the break-down analysis by selecting or clicking on popup window 218 (FIG. 4) associated with a selected sensor. In response, system 100 generates a break-down plot 302 for the selected sensor. FIG. 5 illustrates an exemplary break-down plot for sensor Eng Brg 2Y selected by the user.

System 100 may present break-down plot 302 in same summary tab 202, which includes a plurality of bar elements 304-314. More specifically, bar element 304 represents the overall vibration magnitude detected by sensor Eng Brg 2Y, similar to the bar elements of FIG. 4. Bar elements 308-310 represent vibration magnitudes within individual frequency bands 316. As shown in FIG. 5, for example, the vibration detected by sensor Eng Brg 2Y has a higher magnitude within band 2, corresponding to frequencies between 73.0 Hz and 94.0 Hz, than other bands (e.g., band 0, band 1, and band 3). Further, bar elements 312 and 314 represent vibration magnitudes of signal components at the synchronous frequency (“1X”) and the non-synchronous frequency (“Not 1X”). The synchronous signal refers to a signal component that has the same frequency as the rotation of the engine shaft. For example, if a rotational speed of the engine shaft is 1000 rpm, the synchronous frequency is 16.67 Hz. In general, the synchronous signal is the most significant contributor to the overall vibration. As such, break-down plot 302 provides the user with information to determine the contribution by a given frequency band or frequency component to overall vibration magnitude 304, thereby allowing the user to quickly discover the possible source of the vibration.

According to a further embodiment, break-down plot 302 may be generated by vibration data module 106. Vibration data module 106 may apply signal filtering to extract the frequency components from the waveform data provided by module 128. For example, vibration data module 106 may apply filtering to separate the waveform data into frequency bands 316 and may separate synchronous component 312 from the rest of the waveform data 314.

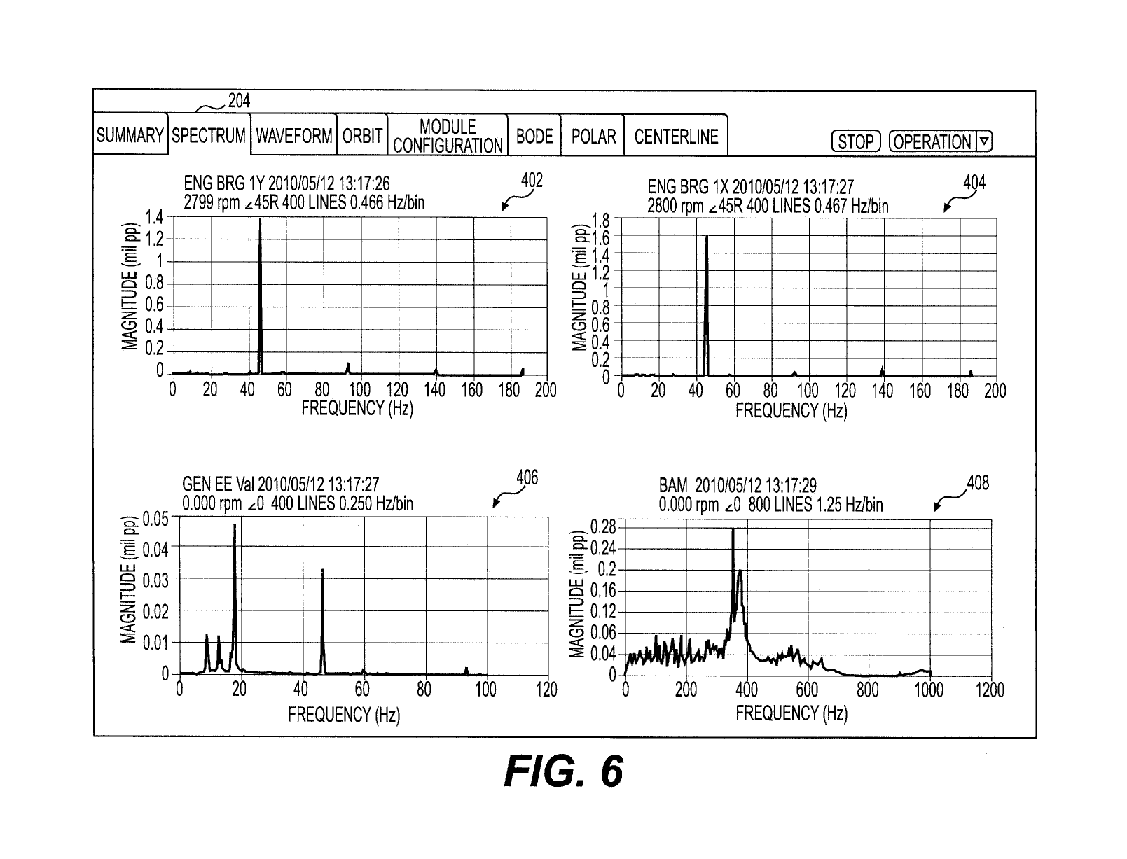

FIG. 6 illustrates an exemplary disclosed spectrum tab 204 of FIG. 4. More specifically, spectrum tab 204 may display a plurality of plots 402-408, which show spectrum analysis of the vibration data received from module 128. Each plot is associated with a sensor identification, such as “Eng Brg 1Y” or “Eng Brg 1X” as discussed above, indicating the associated sensor that provides the signal presented therein. Each of plots 402-408 shows a functional relationship between the magnitude of the vibration and the frequency. In addition, each plot within spectrum tab 204 also provides labeling information including, for example, the location of the associated sensor, the data and time of the data, the rotational speed of the engine system at the time of the data being collected, and the direction of rotation of the engine system (e.g., clockwise or counter clockwise). According to a further embodiment, the spectrum plots shown in FIG. 6 may be generated by vibration data module 106. In generating the spectrum plots, vibration data module 106 may apply Fast-Fourier Transformation (FFT) or other spectrum analysis techniques to the waveform data received from module 128.

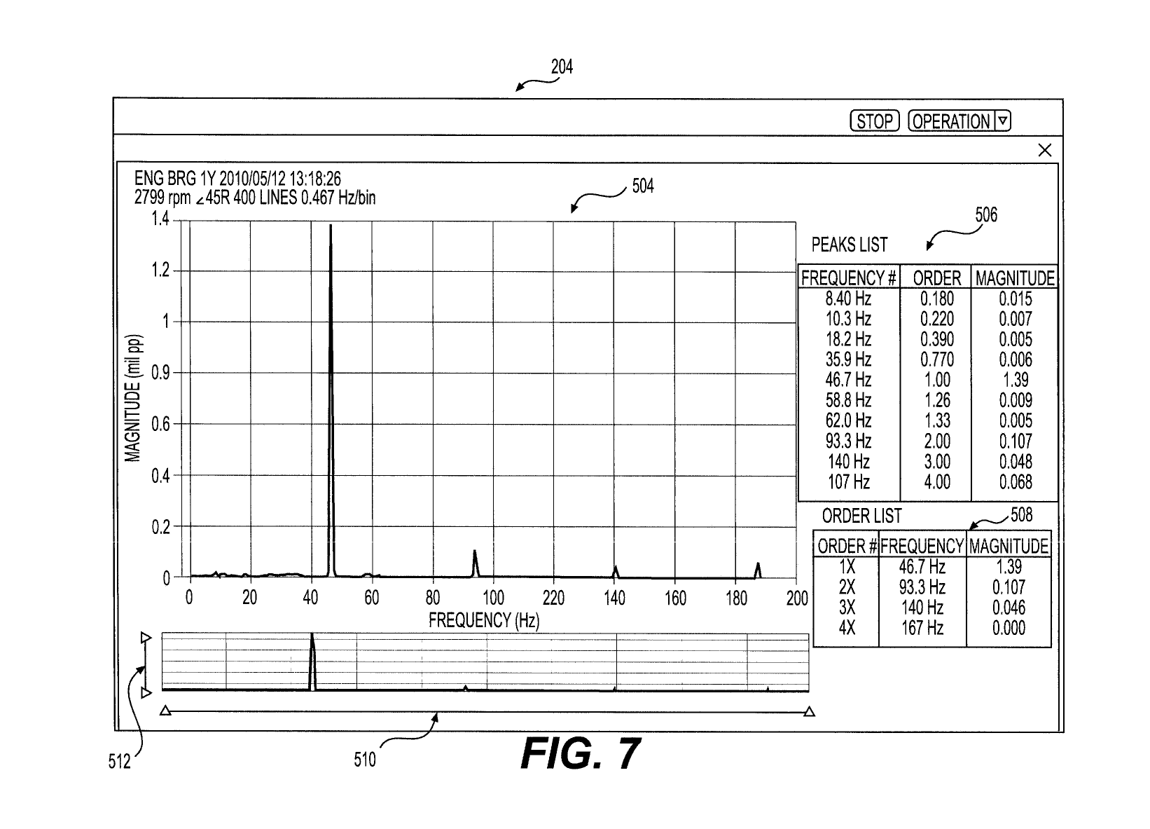

As shown in FIG. 7, system 100 may allow a user to select a particular sensor, such as sensor Eng Brg 1Y, in spectrum tab 204 and present the spectrum analysis of the waveform data provided by the selected sensor. More specifically, in response to the user selection, spectrum tab 204 displays the frequency spectrum on a single spectrum plot 504 for the waveform data from the selected sensor. The vertical axis of spectrum plot 504 represents the peak-to-peak magnitude of the vibration (in mil pp). The horizontal axis represents the frequency range of the vibration (in hertz). In addition, spectrum tab 204 shows a peak list 506 to the right of spectrum plot 504, listing the magnitude, order, and frequency of the ten highest peaks for the spectrum shown in plot 504. As discussed above, the order values listed in peak list 506 are determined with respect to the rotational speed of the engine shaft. An order of 1.000 represent a signal component at a frequency corresponding to the rotational speed of the engine shaft, while the lower and higher order values present signal components at lower or high frequencies. Additionally, spectrum tab 204 display an order list 508, showing the magnitudes and frequencies of various frequency components, such as the synchronous component (“1X”), the second order component (“2X”), the third order component (“3X”), the fourth order components (“4X”). Order list 508 may show the frequency components in an ascending order and a descending order. Further, the highest peaks in respective tables 506 and 508 are highlighted and/or bold font to allow easy identification.

Furthermore, spectrum tab 502 may further include adjustment components 510 and 512 to allow users to adjust the display ranges of the magnitude and frequency of spectrum plot 504. For example, spectrum tab 502 allows a user to narrow or expand the range of the frequency displayed in plot 504 by sliding the tabs of adjustment components 510. Similarly, spectrum tab 502 allows a user to narrow or expand the range of the magnitude displayed in plot 504 by sliding the tabs of adjustment components 512.

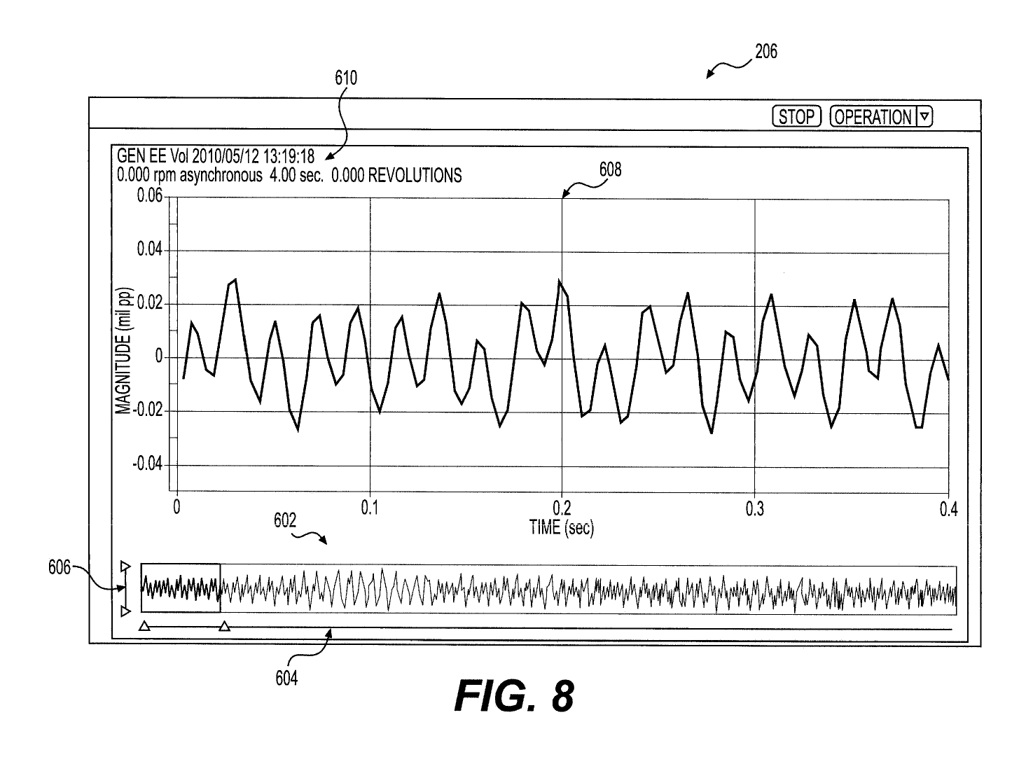

FIG. 8 shows an exemplary disclosed embodiment of waveform tab 206 of FIG. 4. Waveform tab 206 includes a main plot 608, which displays a time-domain waveform of the vibration data collected from a sensor. The horizontal axis of main plot 608 represents the time in second, while the vertical axis of main plot 608 represents the vibration magnitude in a suitable unit, such as mil pp, in/s, or psi, depending on the type of the vibration data being displayed. Waveform tab 206 further includes an information area 610, including the identification of the sensor that provides the waveform, the date and time of the data, the speed of the engine at which the data is collected, etc. Waveform tab 206 further includes a preview area 602, which allows a user to adjust the ranges for the horizontal and vertical axes of main plot 608. The user may select the ranges by sliding the tabs of adjustment elements 604 and 606.

According to an alternative embodiment, waveform tab 206 may have a structure similar to spectrum tab 204 shown in FIG. 6. Specifically, waveform tab 206 may display a plurality of time-domain plots, each of which shows the vibration data collected from a respective sensor. Thus, waveform tab 206 may simultaneously present data from different sources to the user and allow the user to analysis and compare them.

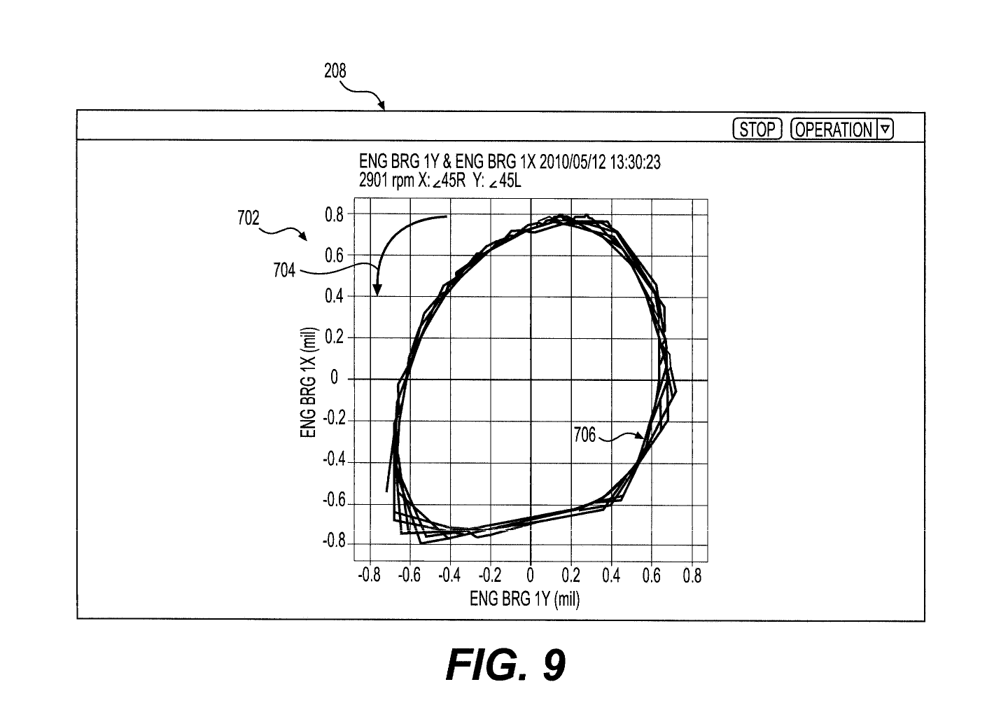

FIG. 9 illustrates an exemplary disclosed embodiment of orbit tab 208 of FIG. 4. Orbit tab 208 includes a main plot 702, which shows the combined magnitude of vibration data collected from a pair of sensors placed on the same rotational component (e.g., a shaft) of the turbine engine. More specifically, the horizontal axis of main plot 702 represents the vibration data collected from sensor Eng Brg 1Y, while the vertical axis represents the vibration data collected from sensor Eng Brg 1X. Main plot 702 shows a line element 706 representing the combined vibration of the sensor pair in one or more shaft revolutions. Main plot 702 further includes an arrow element 704 indicating the rotational direction of the component on which the sensor pair is placed. Again, similar to spectrum tab 204, orbit tab 208 may also display a plurality of plots, each of which shows the combined magnitude from a respective sensor pair.

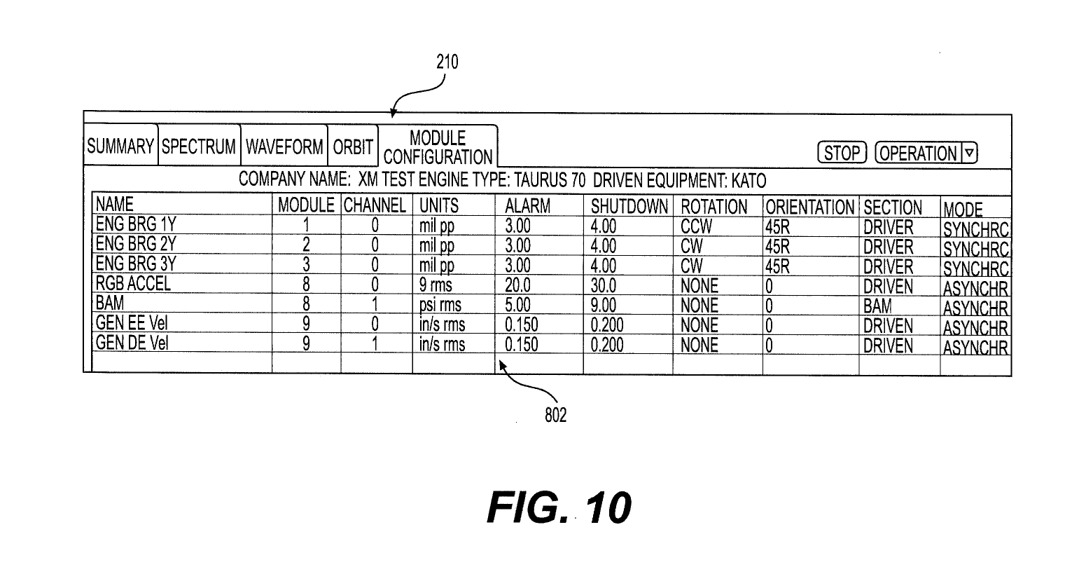

FIG. 10 illustrates an exemplary disclosed embodiment of module configuration tab 210. Module configurations tab 210 displays the configuration of each sensor in a tabular form 802. System 100 automatically retrieves data shown in form 802 when the user navigates to module configurations tab 210. The data may be retrieved from vibration measurement module 128 and/or configuration file module 107 shown in FIG. 1A. Form 802 may include one or more of the following columns:
Sensor name;
Module number;
Channel number;
Units of the vibration data;
Alarm (threshold value for alarm);
Shutdown (threshold value for shutdown);
Rotation direction (clockwise or counter clockwise);
Orientation of the sensor (with respect to the engine top dead center);
Section (engine section that the sensor belongs to, such as driver equipment, driven equipment, or combustor); and
Mode (synchronous or asynchronous).

Form 802 may further provide the following columns (not shown):
FFT window (window type for Fast Fourier Transform);
FFT lines (number of spectral lines);
Freq. orders (number of orders in synchronous mode, “N/A” if in asynchronous mode);
Freq. max (maximum frequency in asynchronous mode, “N/A” if in synchronous mode);
Averages (Number of spectrum averages);
Band 0 (frequency range for Band 0);
Band 1 (frequency range for Band 1);
Band 2 (frequency range for Band 2); and
Band 3 (frequency range for Band 3).

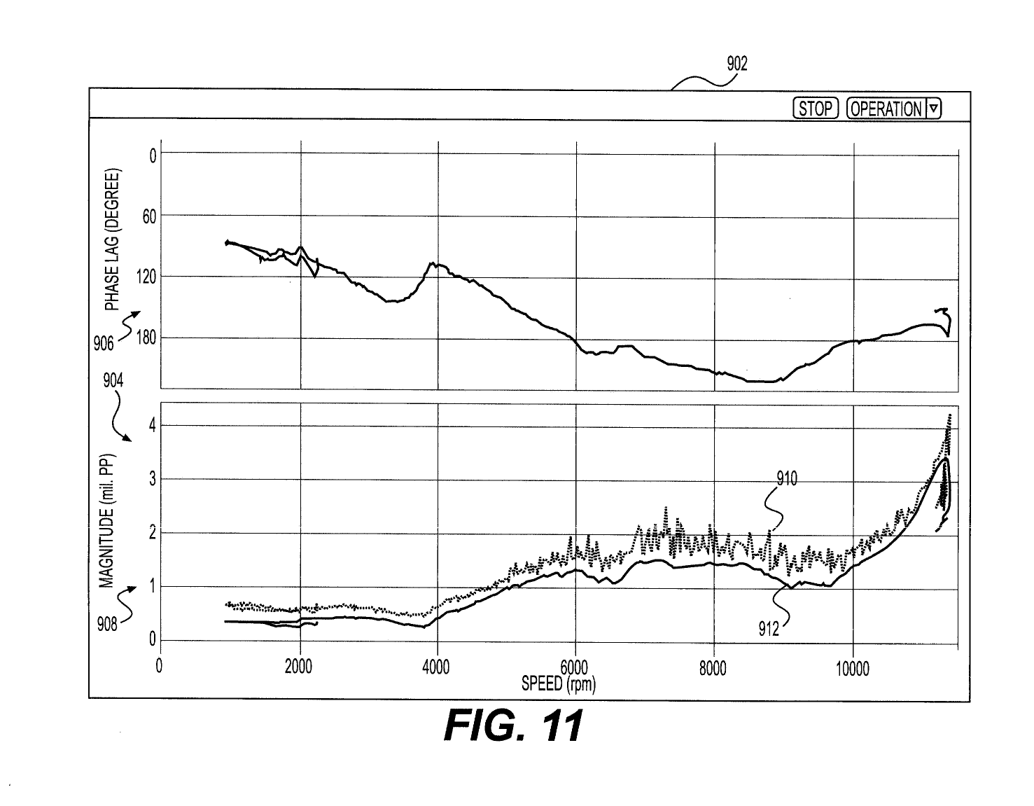

In addition to tabs 202-210 shown in FIGS. 4-10, system 100 may generate additional tabs, such as a bode tab 902, a polar tab 1002, and a centerline tab 1102, as shown in FIG. 4, through display device 102 to presents other aspects of the vibrations data collected from the sensors. FIG. 11 depicts an embodiment of bode tab 902 including a bode plot 904 of the vibration data collected by a sensor during a transient event, such as engine start, engine stop, or manual operation mode. Body plot 904 presents the vibration data in a bode format including two graphs 906 and 908. The horizontal axes of both graphs 906 and 908 represents the shaft speed in revolutions per minute (rpm), increasing from left to right. The vertical axis of graph 906 represents the phase lag (in degrees) of the vibration data, indicating an angular distance of the synchronous (1X) vibration component with respect to a sensor (e.g., tachometer) trigger point on the rotating shaft. The vertical axis of graph 908 represents the peak-to-peak magnitude (in mil pp) of the vibration data. According to a further embodiment, graph 906 shows the phase lag of the signal component at the synchronous frequency (e.g., the synchronous component), while graph 908 shows the magnitude plots of both the synchronous component 912 and overall vibration waveform 910.

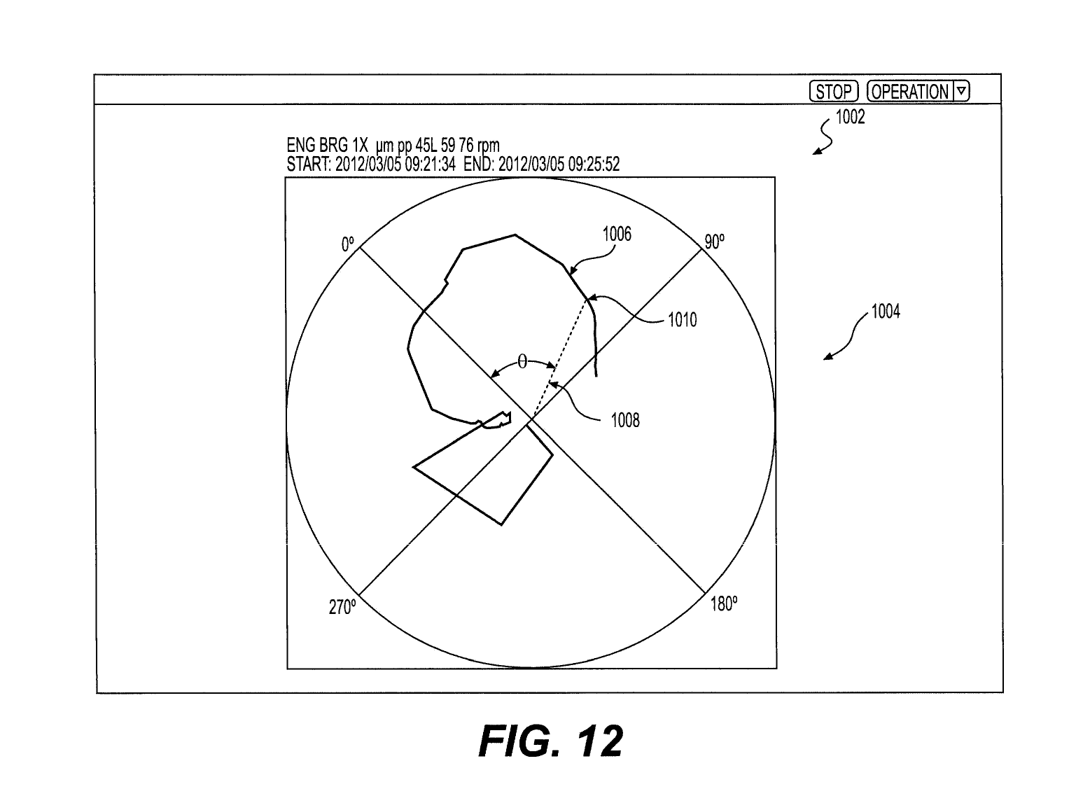

FIG. 12 depicts an embodiment of polar tab 1002 displayed through display device 102. Polar tab 1002 may include a polar plot 1004 showing in polar coordinates a combination of the magnitude and phase of the vibration data collected from a selected sensor (e.g., Eng Brg 1X). According to a further embodiment, polar plot 1004 shows the combination of the phase and peak-to-peak magnitude of the synchronous (1X) signal component. Polar plot 1004 is oriented so that the top of the plot references the engine top dead center. The plot is further labeled clockwise from 0° to 360° (looking upstream relative to turbine air flow, or from the generator driven end towards the exciter end). The 0° point is aligned with the location of the selected sensor. For example, if the selected sensor is oriented 45° to the left of the engine top dead center, as shown in FIG. 12, then the 0° point is at 45° to the left of the engine top dead center, the 90° point is at 45° to the right of the engine top dead center, the 180° point is at 135° to the right of the engine top dead center, and the 270° point is at 135° to the left of the engine top dead center.

Polar plot 1004 further includes a line element 1006 representing a trajectory of the vibration data during a selected time period (e.g., between 9:21:34 and 9:25:52 on Mar. 5, 2012). A distance 1008 between the origin of the coordinate and a data point 1010 represents the magnitude (in mil pp) of a corresponding data point 1010. An angle θ between the sensor location (the 0° point) and data point 1010 represents a phase lag of the synchronous signal component for data point 1010 with respect to the rotation of the shaft. Through polar tab 1002, system 100 provides the user with a visualization of both the magnitude and phase lag of the vibration data, thereby allowing the user to determine a relationship between the phase and the magnitude of the vibration data.

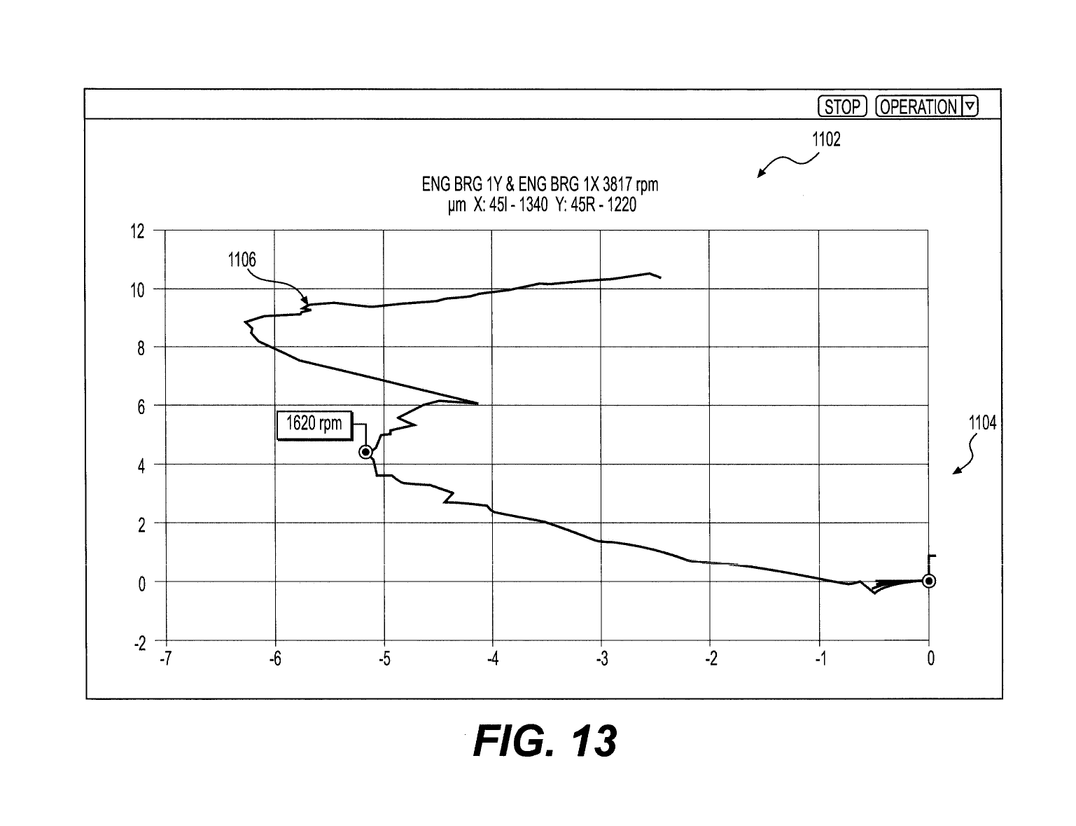

FIG. 13 depicts an embodiment of centerline tab 1102, displayed through display device 102. Centerline tab 1102 may include a shaft centerline plot 1004 having a line element 1006 representing shaft center movement during a selected time period based on the vibration data collected from a sensor pair (e.g., Eng Brg 1Y and Eng Brg 1X) placed on an engine shaft. Specifically, the horizontal axis of centerline plot 1004 represents the horizontal movement of a shaft center, while the vertical axis represents the vertical movement of the shaft center. The first data point captured at the beginning of the time period is mapped to the origin (0,0) of centerline plot 1004, and all subsequent movements of the shaft center are plotted with respect to the origin. For example, if the shaft center at the beginning of the time period (i.e., the first data point) is at (−7,−7) and the shaft center moves to (−8,−9) at a subsequent time, then point one is plotted at (0,0) and the subsequent point is plotted at (−1,−2). Thus, line element 1006 represents a differential shaft center movement with respect to the initial location of the shaft center at the beginning of the time period. In addition, centerline plot 1004 may further show a numeral associated with a user-selected data point, indicating the rotational speed of the engine at which the data are collected. Through centerline tab and a corresponding display 1102, system 100 provides the user with information on the lateral movements of the shaft center.

In addition to the exemplary disclosed user interfaces shown in FIGS. 4-13, system 100 may generate similar tabs or plots in other forms. For example, system 100 may display through display device 102 a cascade plot, which includes multiple vibration spectrums detected by a sensor, each being associated with a different time. As another example, system 100 may display a waterfall plot, which includes multiple vibration spectrums detected by a sensor, each being associated with different engine speeds.

Referring back to FIG. 4, system 100 may further present a menu button 224 in user interface 200. Upon activation of menu button 224 by the user through a mouse or keyboard, system 100 presents a dropdown list. When the user wants to examine, for example, historical data by selecting “Historical” from the dropdown list, system 100 presents a tabular screen of available logs stored in database 114. When the user selects one of the logs, historical data module 108 retrieves the selected data logs from database 114 and presents the historical data to the user through display device 102. Further, system 100 may present an interface for the user to navigate to and select a particular folder in database 114 where one or more logs are stored. System 100 may provide through display device 102 the log name, date range, and number of records in a particular log. The log name may also include a reference to the type of data stored therewithin (e.g., waveform, transient, or periodic data type). After the user selects a data log, system 100 presents through display device 102 a list of all the records in the selected log. System 100 may further allow the user to select records of interest within the selected log and generate appropriate plots as depicted in FIGS. 4-13 based on the selected records.

To facilitate distribution of vibration data, system 100 may also provide the user with the ability to save each screen as shown in FIGS. 4-13 in various file for mats (e.g., PDF, JPG, TIF, etc). Accordingly, system 100 may present a “Print” menu option so the user may activate the menu through mouse or keyboard. In response, system 100 may present a dialog box to guide the user through the printing process, including naming the file and selecting the output file format.

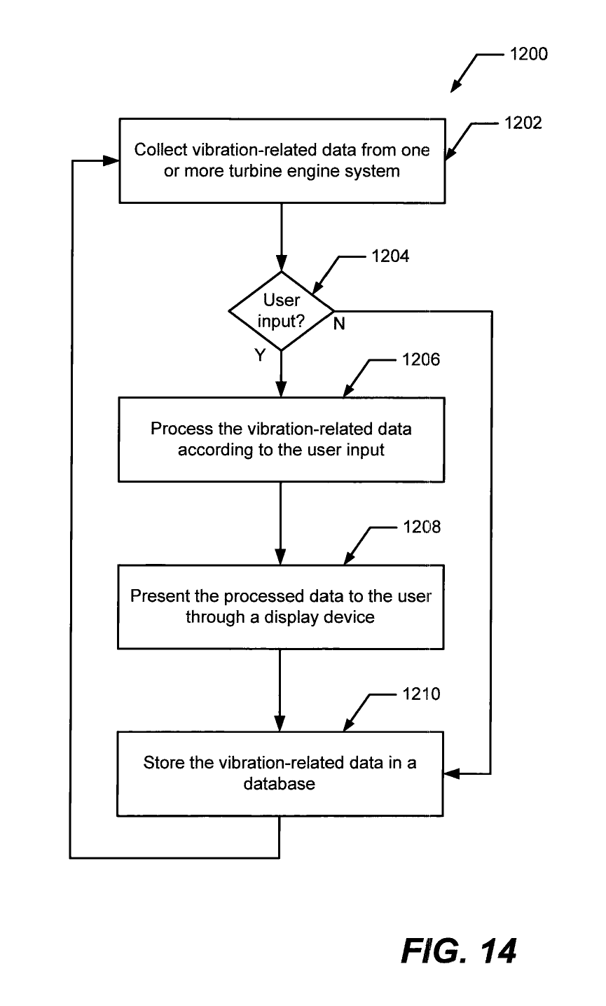

FIG. 14 illustrates a process 1200 for collecting and processing vibration-related data from turbine engine system, according to an exemplary disclosed embodiment. Process 1200 may be implemented using a vibration data collection system similar to system 100 depicted in FIG. 1A. Specifically, at step 1202, the vibration data collection system receives vibration-related data collected from a turbine engine system. The vibration-related data may be provided by, for example, engine controller 126 and measurement module 128, which polls data from sensors 136-142. The vibration-related data may include waveform data reflecting the vibration and pressure detected by the sensors placed on various engine components. Additionally, the vibration-related data may include identifications of the sensors and operational status of the turbine engine, such as rotational speed, rotational direction, etc. The vibration-related data may include scheduled data, which are periodically received from the turbine controller, and unscheduled data, which are received from the measurement module.

At step 1204, the system determines whether a user input is received. If no user input, the system may store the vibration-related data in a database such as database 114 for subsequent retrieval and processing (step 1210). If, at step 1204, a user input is received, the system may process the vibration-related data in response to the user input.

For example, when the user requests a reviewing of a real-time magnitude plot by selecting summary tab 202, the system may extract the magnitude data from the waveform data and map the magnitude data to bar elements as shown in FIG. 4 for individual sensors. When the user activates the break-down analysis as shown in FIG. 5, the system may apply a Fast Fourier Transformation to the waveform data to extract the magnitude and frequency information within selected frequency bands and selected frequency components. When the user requests a viewing of spectrum data by selecting spectrum tab 204, system may apply the Fast Fourier Transformation to the waveform data provided by the measurement module and convert the waveform data to corresponding spectrum data as shown in FIGS. 6 and 7. When a user selects waveform tab 206 as shown in FIG. 8, the system may generate a waveform reflecting the waveform data received from the measurement module. As another example, when the user selects orbit tab 208 as shown in FIG. 9, the system may determine the combined magnitude of the vibration data collected from a pair of sensors placed on the same engine component, such as a shaft. Similarly, the system may determine, in response to the user selection of bode plot 904 as shown in FIG. 11, the relationship between the vibration phase and engine speed and the relationship between the vibration magnitude and engine speed. The system may also combine the magnitude and phase, provided by a given sensor, and determine a polar plot as shown in FIG. 12 in response to the user selection of a polar tab. The system may additionally determine a centerline indicating the differential movement of a shaft center within a time period in response to the user selection of centerline tab 1102.

At step 1208, the system may present the processed data, as shown in FIGS. 4-13, to the user through a display device in response to the user input. In particular, the system may present real-time vibration data as shown in FIGS. 4 and 5 while the vibration-related data are polled from the controller and measurement module 126, 128. As a result, process 1200 allows real-time monitoring of the vibration and engine operation. Process 1200 may also present the processed data based on vibration-related data collected within a time period before the current time. For example, the system may present the spectrum or waveform of vibration data collected from a given sensor (FIGS. 6-8), the combined magnitude data and centerline data generated based on vibration data from multiple sensors (FIGS. 9 and 13), the magnitude and phase collected from a given sensor during a transient operational state (FIG. 11), and the combined magnitude and phase data from a given sensor (FIG. 12). At step 1208, the system may further present configurations of the sensors as shown in FIG. 10, if the user so selects.

In addition, at step 1208, process 1200 may accept additional input from the user and modify the displayed information based on the additional user input. For example, the system may receive user input to toggle between a multi-plot view as shown in FIG. 6 and a single-plot view as shown in FIG. 7. Process 1200 may further receive user input to zoom into a specific portion of the plots or to scale the plots, as shown in FIGS. 7 and 8. The system may further receive user input to select multiple sensors to generate the orbit plot of FIG. 9 or the centerline plot of FIG. 13. The system may further receive user input to define a time period and process the vibration data within the user-defined time period. The system may further retrieve historical data from a database, such as database 114, in response to a user request and process the historical data as described herein.

At step 1210, the vibration-related data collected from the turbine engine may be stored in the database. The data may be stored in corresponding data logs based on the types of the data. For example, periodic data, such as engine speed, collected by general data module 104 may be stored in periodic data logs. Vibration data collected during transient states may be stored in transient data logs. Vibration waveform data collected during steady operational states may be stored in waveform data logs. After step 1210, process 1200 may return to step 1202 to continue receiving vibration-related data from the turbine system. Alternatively, step 1202 may be executed at any time during the entire process.

It will be apparent to those skilled in the art that various modifications and variations can be made to the disclosed systems. Others embodiments will be apparent to those skilled in the art from consideration of the specification and practice of the disclosed systems. It is intended that the specification and examples be considered as exemplary only, with a true scope being indicated by the following claims and their equivalents.

What is claimed is:

1. A method for collecting and processing vibration data from a turbine engine system including a turbine engine and associated driven equipment, comprising:
receiving engine data from the turbine engine system while in service, the engine data including vibration data measured by one or more sensors disposed on the turbine engine system;
receiving user input through a user interface;
processing the vibration data in response to the user input; and
displaying the processed vibration data through the user interface, the processed data being displayed as a function of a time parameter.

2. The method of claim 1, wherein the processing of the vibration data further includes processing the vibration data using a remote computing device communicating with an on-board controller of the turbine engine system through a network.

3. The method of claim 1, wherein the processing of the vibration data includes processing the vibration data using a portion of the engine data other than the vibration data.

4. The method of claim 1, wherein the vibration data includes magnitude data and phase data provided by the one or more sensors in response to the vibration of the turbine engine system.

5. The method of claim 4, further comprising:
mapping the magnitude data to a graphical element; and
displaying the graphical element to the user through the user interface.

6. The method of claim 4, further comprising:
separating the vibration data into a plurality of frequency bands; and
displaying the separated vibration data corresponding to the frequency bands.

7. The method of claim 4, further comprising:
extracting from the vibration data magnitude information of one or more frequency components; and
mapping the extracted magnitude information to respective graphical elements corresponding to the frequency components; and
displaying the graphical elements through the user interface.

8. The method of claim 4, further comprising:
forming, based at least in part on the vibration data, at least one of spectrum data, waveform data, orbit data, polar data, or centerline data; and
displaying the at least one of the spectrum data, the waveform data, the orbit data, the polar data, or the centerline data through the user interface.

9. The method of claim 4, further comprising:
forming, based at least in part on the vibration data, at least two of spectrum data, waveform data, orbit data, polar data, or centerline data; and
displaying the at least two of the spectrum data, the waveform data, the orbit data, the polar data, or the centerline data through the user interface.

10. The method of claim 4, wherein the magnitude data and the phase data are collected during a transient state of the turbine engine system and the displaying of the processed vibration data includes displaying processed vibration data associated with the transient state.

11. The method of claim 10, further comprising:
generating a bode plot representing a functional relationship between the magnitude data and an engine speed associated with the transient state and a functional relationship between the phase data and the engine speed associated with the transient state; and
displaying the bode plot to the user through the user interface.

12. The method of claim 1, further comprising:
triggering at least one of vibration alarm setting or engine shutdown based at least in part on the vibration data.

13. A method for collecting and processing vibration data from a plurality of turbine engine systems, each including a turbine engine and associated driven equipment, comprising:
receiving engine data from the plurality of turbine engine systems while in service, the engine data including vibration data measured by a plurality of sensors disposed on the turbine engine systems;
receiving user input through a user interface;
processing the vibration data in response to the user input; and
displaying the processed vibration data through the user interface, the processed data being displayed as a function of a time parameter associated with at least one of the turbine engine systems.

14. The method of claim 13, wherein the processing of the vibration data further includes processing the vibration data using a remote computing device communicating with controllers of the turbine engine systems through a network.

15. The method of claim 13, wherein the processing of the vibration data further includes processing the vibration data using a portion of the engine data other than the vibration data.

16. The method of claim 13, wherein the vibration data includes magnitude data and phase data provided by the one or more sensors in response to the vibration of the turbine engine systems,
the method further including:
forming, based at least in part on the vibration data, at least one of spectrum data, waveform data, orbit data, polar data, or centerline data; and
displaying the at least one of the spectrum data, the waveform data, the orbit data, the polar data, or the centerline data through the user interface.

17. A system for collecting and processing vibration data from a turbine engine system, comprising:
a general data module configured to receive periodic data from a controller of a turbine engine system, the periodic data representing operational states of the turbine engine system;
a vibration data module configured to receive vibration data from a measurement module associated with the turbine engine system and generate a functional relationship between the vibration data and a time parameter according to user input, the vibration data including information about vibration of the turbine engine system provided by a plurality of sensors associated with the turbine engine system;
a database configured to store the periodic data and the vibration data as historical data and provide the historical data in response to the user input;
a historical data module configured to retrieve the periodic data and the vibration data from the database; and
a display device configured to display the periodic data, the vibration data, and the historical data.

18. The system of claim 17, wherein the turbine engine system includes at least one of a gas producer, a power turbine, and driven equipment; and
the vibration data module is further configured to receive vibration data from the at least one of the gas producer, the power turbine, and the driven equipment through the measurement module.

19. The system of claim 17, wherein,
the general data module is further configured to receive the periodic data from controllers of a plurality of turbine engine systems; and
the vibration data module is further configured to receive vibration data from measurement modules associated with the plurality of turbine engine systems.

20. The system of claim 19, wherein the vibration data module and the general data module are located at a remote location and are configured to receive the periodic data and the vibration data from the controllers and the measurement modules of the turbine engine systems through a network.
